(19) United States
(12) Patent Application Publication
(10) Pub. No.: US 2013/0335531 A1
(43) Pub. Date: Dec. 19, 2013

(54) APPARATUS FOR PROJECTING GRID PATTERN

(71) Applicants: Keyoung Ja Lee, Anyang-si (KR); Su yeoung Choi, Anyang-si (KR); Su Heyng Choi, Anyang-si (KR)

(72) Inventors: Keyoung Ja Lee, Anyang-si (KR); Su yeoung Choi, Anyang-si (KR); Su Heyng Choi, Anyang-si (KR)

(73) Assignee: SHARP KABUSHIKI KAISHA, Osaka-shi, Osaka (JP)

(21) Appl. No.: 14/002,119

(22) PCT Filed: Feb. 28, 2012
(86) PCT No.: PCT/KR12/01495

§ 371 Date: Aug. 28, 2013

(30) Foreign Application Priority Data
Feb. 28, 2011 (KR) 10-2011-0017876

(51) Int. Cl. G06T 7/00

(52) U.S. Cl. CPC G06T 7/0051
USPC 348/46

(57) ABSTRACT

The present invention relates to an apparatus for projecting a grid pattern, and more particularly, to an apparatus for projecting a grid pattern that projects an image of a grid pattern onto a test object during a three-dimensional measurement. The apparatus for projecting a grid pattern comprises: a camera which takes, as an input, a grid pattern image using grid pattern projecting means including a grid pattern signal generating unit and a grid pattern emitting unit, wherein the grid pattern signal generating unit receives grid pattern information to emit light in the form of grid pattern onto the test object and generates a grid pattern signal, and controls the grid pattern signal, wherein the grid pattern emitting unit controls a micro-mirror for a light source and a laser scanner using the grid pattern signal to emit a grid pattern; information processing means for extracting a three-dimensional image; and output means. According to the present invention, the size of the apparatus for projecting a grid pattern may be reduced such that the apparatus may be internally or externally built into a mobile device or three-dimensional measurement device. The apparatus for projecting a grid pattern of the present invention may solve the focusing problems of conventional apparatuses for projecting a grid pattern, and may project a grid pattern image to a high-speed camera in real time to perform a three-dimensional measurement.

### TECHNICAL FIELD

The present invention relates to an apparatus for projecting a grid pattern projected onto a camera during a three-dimensional measurement, and more particularly, to an apparatus capable of facilitating a three-dimensional measurement of a test object by sequentially projecting grid pattern images onto the test object by coupling a camera built into a mobile device (for example, a smart phone, a smart pad, and the like) and a three-dimensional measurement device with an apparatus for projecting a grid pattern, and providing the projected grid pattern images to the camera.

### BACKGROUND ART

Conventionally, a three-dimensional measurement method of a non-contact test object in industry is mainly based on an optical triangulation method and as a main method, a laser mechanism, a mechanism for measuring a space encoding three-dimensional shape using grid patterns and a camera, a moiré mechanism, and the like, have been used. Most of the measurement methods of the related art have used dedicated equipment for three-dimensional measurement.

FIG. 1a is a schematic view illustrating a lighting unit and an image input unit provided in a three-dimensional measurement apparatus of a test object according to the related art.

An example of the three-dimensional measurement of the test object illustrated in FIG. 1a is as follows.

The lighting unit includes a grid pattern projector 290 and a grid focusing lens 291, in which light irradiated from the grid pattern projector is irradiated on a surface of a test object 11 and an image of a grid pattern 510 projected on the surface of the test object 11 is input to a camera 110.

Therefore, coordinate points for a three-dimensional position of the test object may be calculated by sequentially projecting grid patterns 511, 512, 513, 514, and 515 as illustrated in FIG. 1b onto the surface of the test object and then using grid pattern images input to the camera 110.

According to the three-dimensional measurement apparatuses of the test object view the related art, most of the three-dimensional measurement apparatuses include a dedicated equipment in which the grid pattern projector and the camera are integrated. Therefore, there are problems in costs, a restriction of installation space, the focusing of the images of the grid patterns for projected positions at the time of projecting grid patterns onto the test object, and the like, when a general user uses the grid pattern projector.

The features of a conventional apparatus for projecting a grid pattern are as follows.

The apparatus for projecting a grid pattern may be implemented by various methods. FIG. 3a illustrates a structure of an example of the apparatus for projecting a grid pattern which includes a light source 260, lenses 267 and 268 required for light collection and focusing, in which the apparatus for projecting a grid pattern controls the lenses 267 and 268 to focus the images of the grid patterns for the projected positions of the test object.

Most of the apparatuses for projecting a grid pattern may be classified into a mechanical pattern projecting apparatus using a pattern film and an electronic pattern projecting apparatus which may change a pattern shape to various shapes by using a light engine for an image projector, such as an LCD, a TFT, a DLP, or the like.

The electronic pattern projecting apparatus uses input grid pattern information as illustrated in FIG. 1b to synchronize the image input timing of the camera and then project various grid patterns and uses an LED, a laser, a halogen, or the like, as the light source.

However, there are problems such as a lowering of the light efficiency in relation with the collection of light using the light source such as an LED or a halogen, etc., a difficulty in focusing of a distance between the test object and the pattern projecting apparatus, a difficulty in miniaturization of the pattern projecting apparatus, and the like.

Further, most of the electronic pattern projecting apparatus of the related art has a screen projection speed up to 240 frames per second (fps) or less as a frame rate, which causes a problem at the time of performing the three-dimensional measurement using the grid patterns projected in real time onto a high-speed camera having 1000 fps or higher, for example.

### DISCLOSURE

### Technical Problem

In consideration of the above-mentioned problems, it is an object of the present invention to provide an apparatus for projecting a grid pattern which is configured in a small size and internally or externally built into a mobile device provided with a widely spread camera and a three-dimensional measurement device so as to perform a three-dimensional measurement by projecting grid pattern images onto a high-speed camera, thereby solving a lowering of the light efficiency and a difficulty in focusing of the conventional apparatus for projecting a grid pattern.

### Technical Solution

To achieve the above objects, an apparatus for projecting a three-dimensional grid pattern according to a preferred embodiment of the present invention includes:

a grid pattern signal generating unit configured to generate a grid pattern signal by receiving grid pattern information so as to emit light to a test object and control the grid pattern signal;

a grid pattern projecting means which includes a grid pattern emitting unit configured to control a light source and a micro mirror for a laser scanner by using the grid pattern signal generated from the grid pattern signal generating unit to emit a grid pattern;

an image input means configured to allow a camera to receive a grid pattern image projected onto a surface of the test object;

an information processing means configured to provide a sequential projection timing of grid patterns and an input timing of the grid pattern image from the grid pattern signal generating means, receive and store the grid pattern image from the image input means, and form a three-dimensional image by extracting three-dimensional coordinates by using the received grid pattern image of the test object; and

an output means configured to display the three-dimensional image of the information processing means.

The grid pattern signal generating unit may sequentially receive the grid pattern information and generate the grid pattern signal at the projection timing of the grid pattern using the received grid pattern information.

In the grid pattern emitting unit, the light source may be configured of a line laser including a laser diode and at least one lens to irradiate light in a line pattern to a surface of the micro mirror for a laser scanner and the micro mirror for a laser scanner may include a micro mirror for one-dimensional laser scanner which repeatedly rotates at a predetermined angle and period around one axis.

A pattern structure of the grid pattern image emitted from the grid pattern emitting unit may be configured to have a grid pattern which is formed of at least one horizontal grid line image or at least one vertical grid line image.

The grid pattern projecting means may be internally or externally built in an apparatus in which the image input means, the information processing means, and the output means are mounted.

The image input means may receive the grid pattern image projected onto the test object at the projection timing of the grid pattern and transmit the received grid pattern image to the information processing means and the information processing means may extract three-dimensional coordinates using the grid pattern image to display the grid pattern image and the three-dimensional image information on an output means.

### Advantageous Effects

As mentioned above, according to the apparatus for projecting a grid pattern according to the present invention, the apparatus for projecting a grid pattern includes the one-dimensional laser scanner and the line laser to project the grid pattern images onto the test object, thereby performing the three-dimensional measurement.

Accordingly, compared to the related art, the apparatus for projecting a grid pattern according to the present invention can be more readily manufactured and miniaturized than the apparatus for projecting a grid pattern using the conventional two-dimensional laser scanner and dot laser and can improve the lowering of the light efficiency in relation with the collection of light using the light source such as an LED or a halogen, etc., and the focusing with the projected object, and the like, which are the problems in the apparatus for projecting a grid pattern of the related art.

Further, the apparatus for projecting a grid pattern of the related art has a difficulty in the three-dimensional measurement using the grid patterns in real time by the high-speed camera due to the reduction in the frame rate speed at the time of projecting the grid patterns, but the apparatus for projecting a grid pattern according to the present invention can readily solve the problems.

The present invention can configure the apparatus for projecting a grid pattern to be implemented in a small size and externally and internally built into the mobile device (for example, a smart phone, a smart pad, a digital camera, and the like) provided with an existing camera and the three-dimensional measurement apparatus to readily perform the three-dimensional measurement as needed. Accordingly, the apparatus for projecting a grid pattern can be applied to various fields, such as a three-dimensional measurement of products, production of the three-dimensional avatar, geometrical measurement in a facial plastic surgery, three-dimensional biometrics, and three-dimensional advertisement of goods in the virtual space, by the three-dimensional measurement using the smart phone.

In addition, as the fields requiring the three-dimensional measurement by coupling the camera with the apparatus for projecting a grid pattern, the present invention can be applied to, for example, the motion recognition field of three-dimensionally measuring the motion state of a user and the three-dimensional measurement field by coupling the camera and the apparatus for projecting a grid pattern with a smart TV.

### DESCRIPTION OF DRAWINGS

FIG. 1a is a schematic view illustrating an apparatus for projecting a grid pattern during a three-dimensional measurement of a test object according to one example of the related art.

FIG. 1b is a schematic view illustrating grid patterns sequentially projected during a three-dimensional measurement of a test object according to one example of the related art.

FIG. 2 is a schematic view illustrating an apparatus for projecting a grid pattern during a three-dimensional measurement of a test object according to an embodiment of the present invention.

FIG. 3a is a view illustrating an example of a grid pattern projector of the related art.

FIG. 3b is a view illustrating an example of a configuration of a line laser.

FIG. 3c is a view illustrating an example of one-dimensional laser scanner.

FIG. 3d is a view illustrating an example of a two-dimensional laser scanner.

FIG. 3e is a view illustrating an example in which grid pattern images are projected onto a screen member by using the two-dimensional laser scanner and a dot laser.

FIG. 3f is a view illustrating an example in which grid patterns are projected onto the screen member by using the one-dimensional laser scanner and the line laser.

FIG. 4a is a view illustrating an example of the relationship with grid pattern images projected by emitting the grid patterns from a grid pattern emitting unit, based on a waveform generated from a grid pattern signal generating unit according to an embodiment of the present invention.

FIG. 4b is a view illustrating another example of the relationship with the grid pattern images projected by emitting the grid patterns from the grid pattern emitting unit, by using the waveform generated from the grid pattern signal generating unit according to the embodiment of the present invention.

FIG. 5a is a view illustrating a modified example of the grid pattern emitting unit according to the embodiment of the present invention.

FIG. 5b is a view illustrating another modified example of the grid pattern emitting unit according to the embodiment of the present invention.

FIG. 6a is a plan view illustrating an example of a grid pattern projecting means according to the embodiment of the present invention.

FIG. 6b is a plan view of an example in which the grid pattern projecting means according to the embodiment of the present invention is externally built into a mobile device.

FIG. 6c is a plan view of an example in which the grid pattern projecting means according to the embodiment of the present invention is internally built into the mobile device.

FIG. 7a is a side view illustrating an example in which the grid patterns according to the embodiment of the present invention are projected onto the test object.

FIG. 7b is a perspective view of an example of grid pattern images acquired by projecting the grid patterns according to the embodiment of the present invention onto the test object.

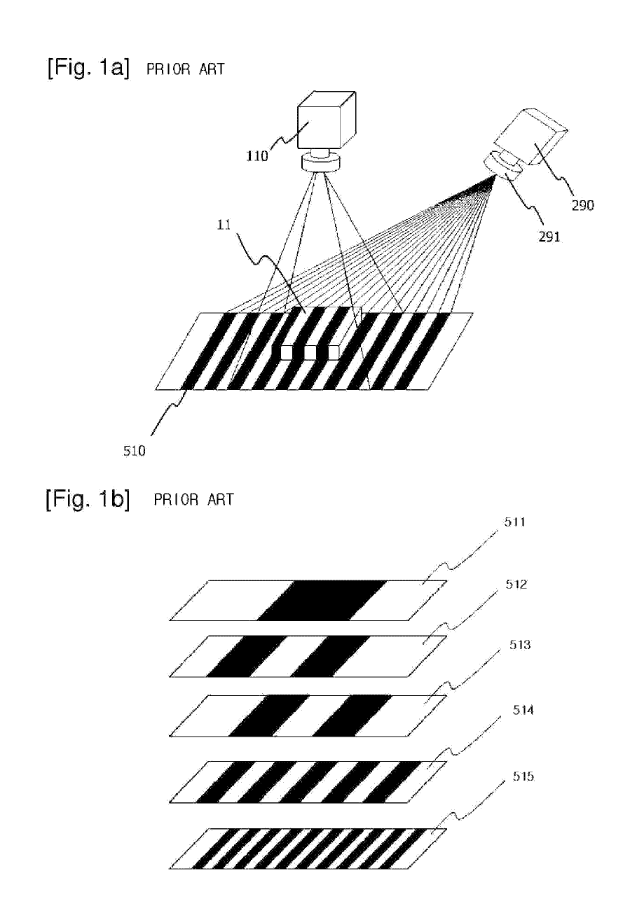

### BEST MODE

Hereinafter, a three-dimensional measurement apparatus using an apparatus for projecting a grid pattern according to the present invention will be described with reference to the accompanying drawings.

The ‘unit’ or ‘means’ which are used in the present embodiment may include software components, drivers, firmware, microcode, circuits, data, and the like.

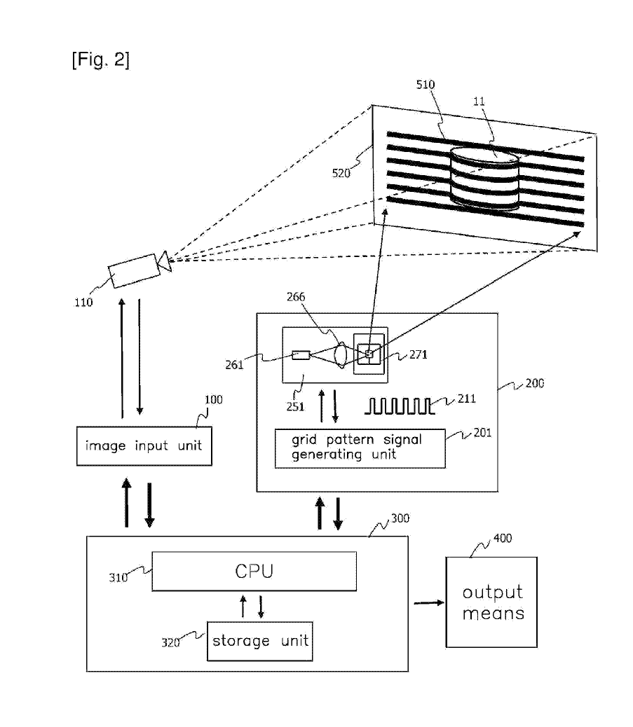

FIG. 2 is a schematic view illustrating a three-dimensional measurement apparatus of a test object according to an embodiment of the present invention, in which the three-dimensional measurement apparatus includes an image input unit 100, a grid pattern projecting means 200, an information processing means 300, and an output means 400.

The image input unit 100 serves to allow a camera to receive grid pattern images sequentially projected onto a test object 11 and transmit the grid pattern images to the information processing means 300 and is synchronized with a grid pattern projecting timing of a grid pattern signal generating unit 201.

The grid pattern projecting means 200 is a means which may project the grid patterns onto the test object 11 and includes a grid pattern signal generating unit 201 and a grid pattern emitting unit 251 which includes a line laser 261, a cylinder lens 266, and one-dimensional laser scanner 271.

When the three-dimensional measurement is started, the information processing unit 300 sequentially transmits projected signals of grid patterns to the grid pattern projecting means 200 and receives the grid pattern images projected onto the test object from the image input means 100 to sequentially store the grid pattern images in a storage unit 320. The storage unit 320 may include a memory, a hard disk, and the like.

The output means 500 includes a monitor. The output means 500 outputs the grid pattern images, three-dimensional image information, or the like, which are processed by the information processing means 400.

Hereinafter, an operation and an effect of the present invention configured as described above will be described in more detail with reference to the accompanying drawings.

As illustrated in FIG. 2, the grid pattern projecting means 200 is a means which may project the grid patterns onto the test object 11 and includes the grid pattern signal generating unit 201 and the grid pattern emitting unit 251 which includes the line laser 261, the cylinder lens 266, and the one-dimensional laser scanner 271.

The grid pattern signal generating unit 201 receives information on the grid patterns from the information processing means 300 to convert it into a signal, transmits a signal waveform 211 to the line laser 261 of the grid pattern emitting unit 251 at a starting timing of the grid pattern images in the one-dimensional laser scanner 271, and transmits a signal to the information processing means 300 at a projecting timing of the grid pattern images.

The information processing means 300 transmits the signal at the starting time of the grid pattern to the camera 110 of the image input means 100 to synchronize the projecting timing of the grid pattern image from the one-dimensional laser scanner 271 with the starting timing of the image input from the camera so as to receive the grid pattern image.

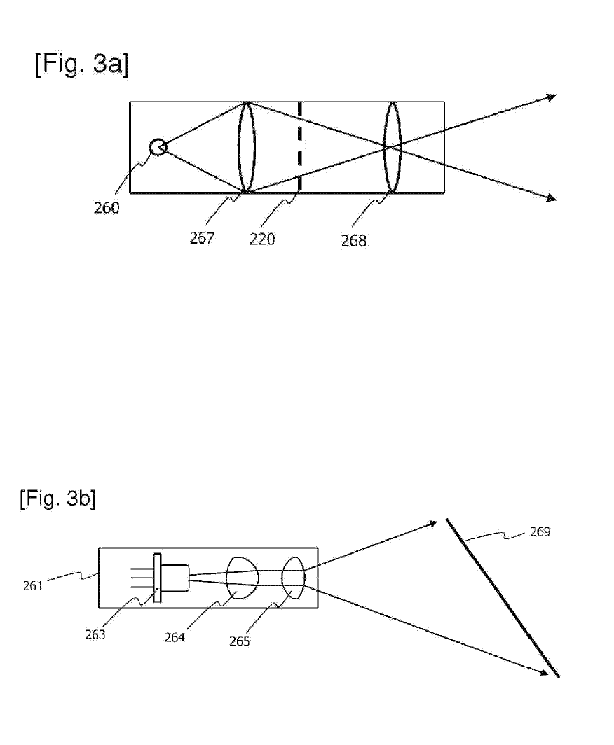

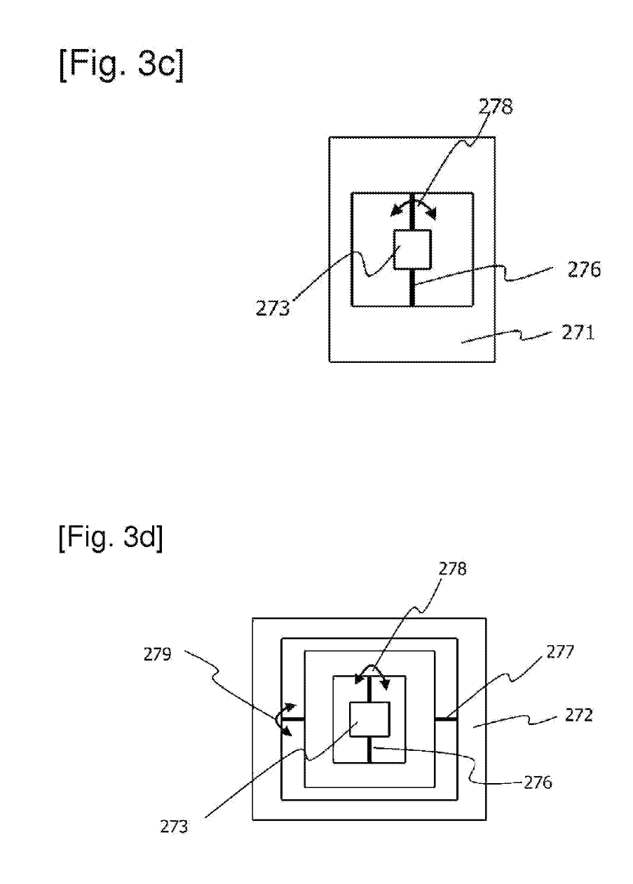

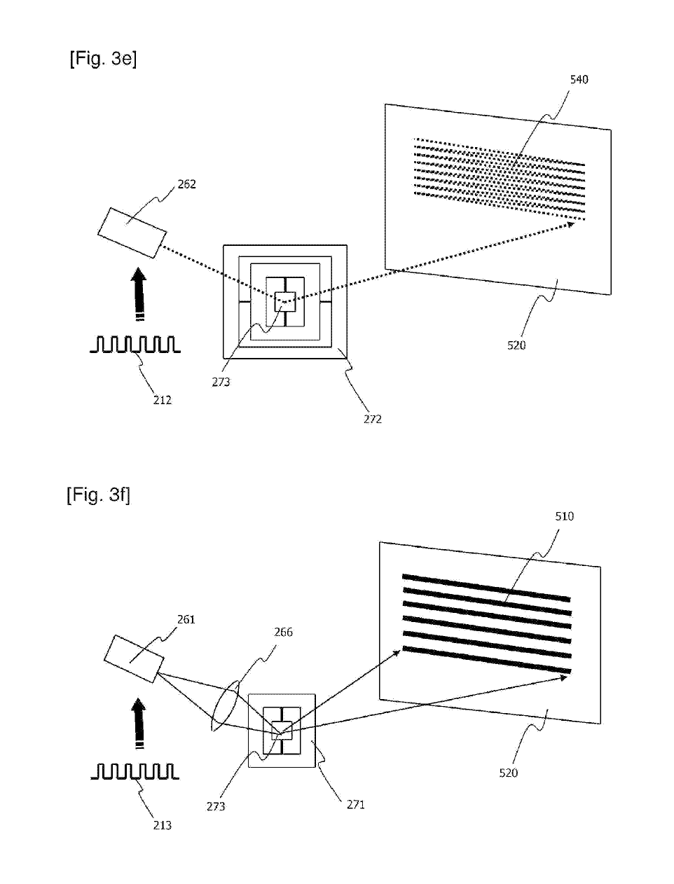

The grid pattern emitting unit 251 performs an x-axis horizontal rotational motion 278 on a micro mirror 273 of the one-dimensional laser scanner 271 at a predetermined angle as illustrated in FIG. 3, and modulates light of the line laser 261 by on/off at a starting position of the projection of the grid pattern in the one-dimensional laser scanner 271 as illustrated in FIG. 3f to transmit the irradiated light of a line pattern through the cylinder lens 266 so as to collect the light and irradiate the collected light onto the surface of the micro mirror 273 and projects the light of the line laser 261 reflected from the surface of the micro mirror 273 onto a screen member 520 in a grid pattern 510 having a line form.

As a wavelength band of the laser of the line laser 261, a visible rays or infrared based band may be used.

In general, the laser scanner is classified into the one-dimensional laser scanner 271 as illustrated in FIG. 3c and a two-dimensional laser scanner 272 as illustrated in FIG. 3d.

As illustrated in FIG. 3d, the two-dimensional laser scanner 272 includes an x-axis support 276 and a y-axis support 277 around the micro mirror 273 and performs a biaxially rotational motion as the x-axis horizontal movement 278 and a y-axis vertical rotational motion 279 with a predetermined period and when a signal waveform 212 is projected onto the surface of the micro mirror 273 using the dot laser 262 by the method illustrated in FIG. 3e, a pattern image 540 may be projected onto the screen member 520, which may thus be configured as a two-dimensional image projector.

For example, referring to FIGS. 3e and 3d, when the x-axis horizontal movement 278 of the two-dimensional laser scanner 272 performs the horizontal rotational motion 14,400 times or more per second, two line patterns may be formed during one rotational motion to form 28,800 line patterns. In addition, when the y-axis vertical rotational motion 279 performs the rotational motion 30 times per second, the screen projection of 60 frame rates may be performed and when the dot laser 262 may perform the modulation above 20 Mhz (640 pixels×480 lines×60 frames=18.43 Mhz), a VGA-level pattern image having a resolution of 640×480 having a frame rate of 60 hz may be projected.

As the product of the two-dimensional laser scanner 272 which is currently developed by the above-mentioned method and available in the market, for example, a product available from Microvision (www.microvision.com) company is present and there are advantages in that the two-dimensional laser scanner is miniaturized by using a micro electro mechanical systems (MEMS) technology and does not have to perform the focusing even at any projected positions in terms of low power and laser characteristics.

However, the apparatus for projecting a grid pattern using the two-dimensional laser scanner 272 is more difficult to be manufactured than the one-dimensional laser scanner 271 and the high-speed camera of 60 hz or more per second is difficult to perform the three-dimensional measurement in real time.

According to the present invention, the apparatus for projecting a grid pattern for the high-speed camera having the high frame rate using the one-dimensional laser scanner 271 can be developed.

A detailed description thereof will be provided below.

FIG. 3b is a view illustrating an example of a component of the line laser 261 which includes a laser diode 263 as a light source, a collimating lens 264 forming a light path to allow light to be close to a parallel light, and a cylinder lens 265 irradiating light in a line form, thereby forming the light in a line pattern 269.

Referring to FIGS. 3c and 3f, the one-dimensional laser scanner 271 as illustrated in FIG. 3c is configured of the x-axis support 276 around the micro mirror 273 and performs the x-axis horizontal rotational motion 278 at a predetermined period and when the light of the line laser 261 using a signal waveform 213 as illustrated in FIG. 3f is irradiated and then the cylinder lens 266 is added to the light path, the light is collected and irradiated on the surface of the micro mirror 273 and the light is irradiated to the screen member 520 depending on a rotating angle of the micro mirror 273 to project the image of the grid pattern 510, which may thus be configured as a two-dimensional grid pattern image projector.

Further, the image of the three-dimensional grid pattern 510 may be projected by using the line pattern 269 of the line laser 261 to which the signal waveform 213 of the one-dimensional laser scanner 271 is transmitted for a period of ½ of one rotation period of the micro mirror 273 as illustrated in FIG. 3f.

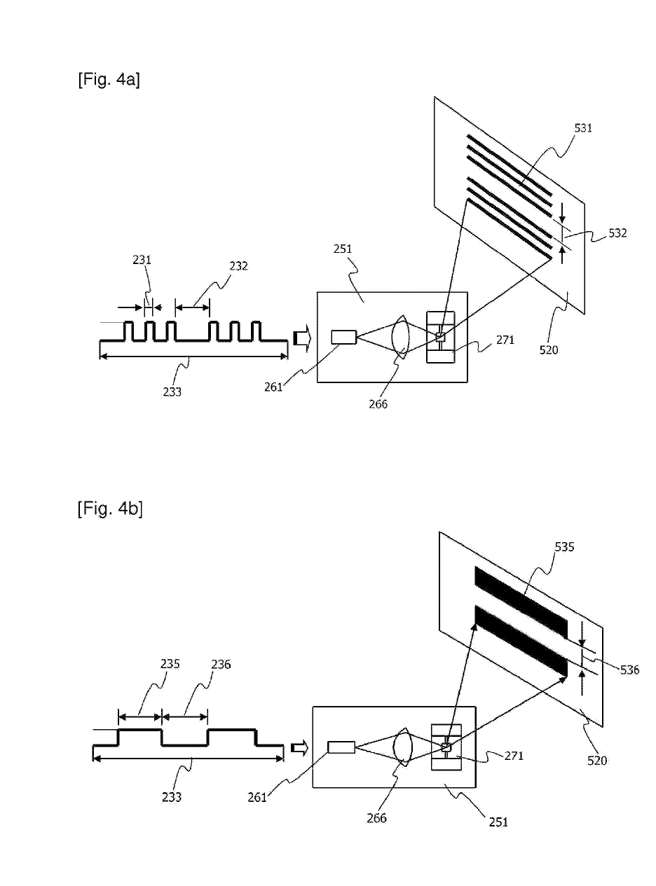

For example, as illustrated in FIGS. 4a and 4b, the signal waveform 233 is transmitted to the line laser 261 of the grid pattern emitting unit 251 from the one-dimensional laser scanner 271 in the grid pattern signal generating unit for a ½ rotating period of the micro mirror, such that in FIG. 4a, a waveform 231 and a grid pattern 531 of the screen member 520 coincide with a waveform 232 coincides with a grid pattern 532 of the screen member 520 and similar to this, in FIG. 4b, a waveform 235 and a grid pattern 535 of the screen member 520 coincide with a waveform 236 and a grid pattern 536 of the screen member 520.

According to the embodiment of the present invention, a configuration of a grid pattern image of a screen resolution of a VGA-level 640×480 having a frame rate of 60 hz is as follows.

The grid pattern emitting unit includes the one-dimensional laser scanner 271 and the line laser 261. When the one-dimensional laser scanner 271 is driven at a low speed of 30 hz per second, the screen is configured of two frames at one rotating period to be able to configure a screen having 60 frames per second and the line laser 261 may be configured of modulation about 30 khz (480 lines×60 frames=28.8 khz) or more, such that the apparatus for projecting a grid pattern may be simply manufactured compared to configuring process of the apparatus for projecting a grid pattern using the conventional two-dimensional laser scanner and dot laser.

Further, an example of the case in which the apparatus for projecting a grid pattern is mounted in the high-speed camera will be described below.

When the one-dimensional laser scanner 271 is driven at 1000 hz, the grid pattern images may be projected at 2000 frames per second and the line laser 261 is configured of modulation about 1 Mhz (480 lines×2000 frames=960 khz) or more to be able to manufacture the three-dimensional measurement apparatus using the apparatus for projecting a grid pattern for the high-speed camera having a frame rate of 2000 times or less.

The image input unit 100 serves to allow the camera to receive the grid pattern images sequentially projected onto the test object 11 and transmit the grid pattern images to the information processing means and is synchronized with the grid pattern projecting timing of the grid pattern signal generating unit 201.

When the three-dimensional measurement is started, the information processing unit 300 sequentially transmits the projected signals of the grid patterns to the grid pattern projecting means 200 and receives the projected grid pattern images from the image input means 100 to sequentially store the grid pattern images in the storage unit 320. The storage unit 320 may include a memory, a hard disk, and the like.

Further, a central processing unit (CPU) 310 extracts data for three-dimensional coordinates by performing an arithmetic and logic operation or image data processing using the sequentially input grid pattern images to be able to configure a wire frame and configure a three-dimensional text mapping image.

The output means 500 includes a monitor. The output means 500 outputs the grid pattern images, three-dimensional image information, or the like, which are processed by the information processing means 400.

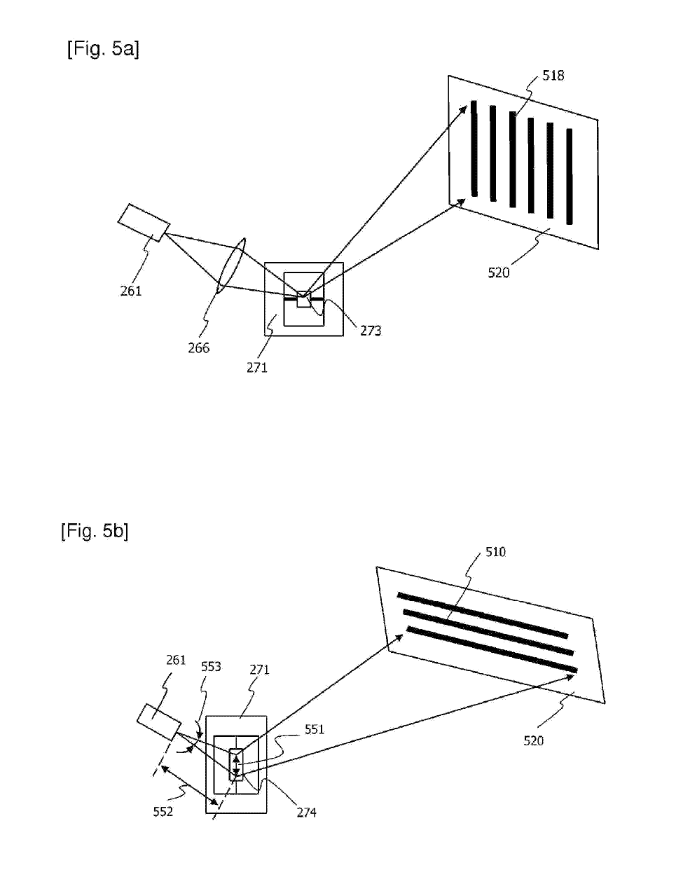

The pattern structure of the image of the grid pattern 510 emitted from the grid pattern emitting unit 251 is configured to have the grid patterns which are formed of at least one horizontal grid line image or at least on vertical grid line image. FIGS. 5A and 5B illustrate a modified example of the grid pattern emitting unit according to the present invention, respectively.

In FIG. 5a, the one-dimensional laser scanner 271 is mounted by rotating 90°, and a light pattern in a vertical line is projected from the line laser 261, collected by the cylinder lens 266, reflected from the surface of the micro mirror 274, and projected onto the screen member 520, and the pattern structure of the projected image of the grid pattern 518 is formed in at least one vertical grid line image.

As illustrated in FIG. 5b, by the one-dimensional laser scanner 271 included in the grid pattern emitting unit, the line pattern projected from the line laser 261 is reflected from the surface of the micro mirror 273 without being collected by the cylinder lens 266 as illustrated in FIG. 5a and is projected onto the screen member 520, the light of the line laser 261 is irradiated to the surface of the micro mirror 274 and a surface dimension 551 of the micro mirror 274 increases in proportion to an angle 553 of the light path in the line pattern of the line laser 261 and a distance 552 from the micro mirror 274 to reflect the irradiated light.

The present invention is not limited to the above description, but may be modified and changed within the range departing from the gist of the present invention and it is to be construed that the modified and changed technologies belong to the following claims.

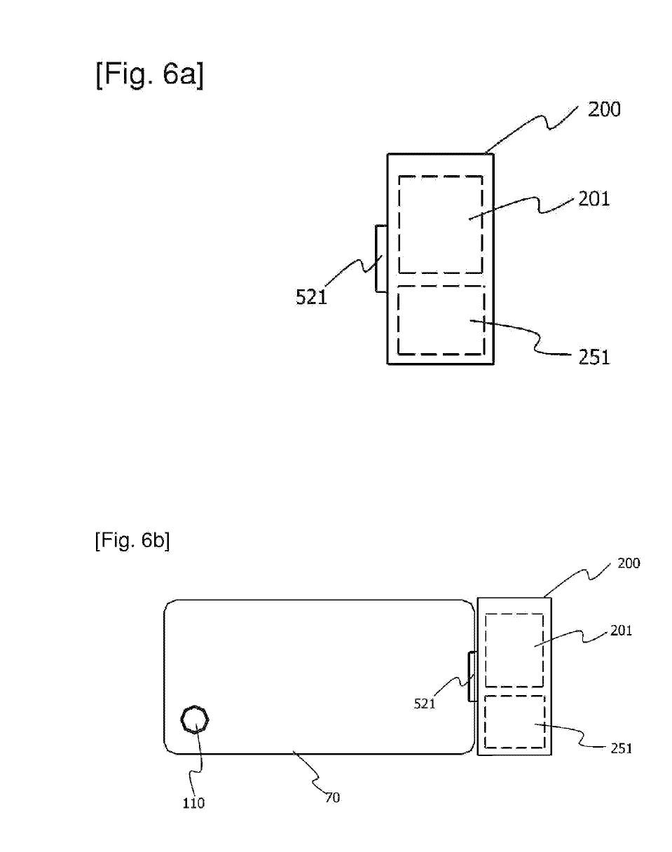

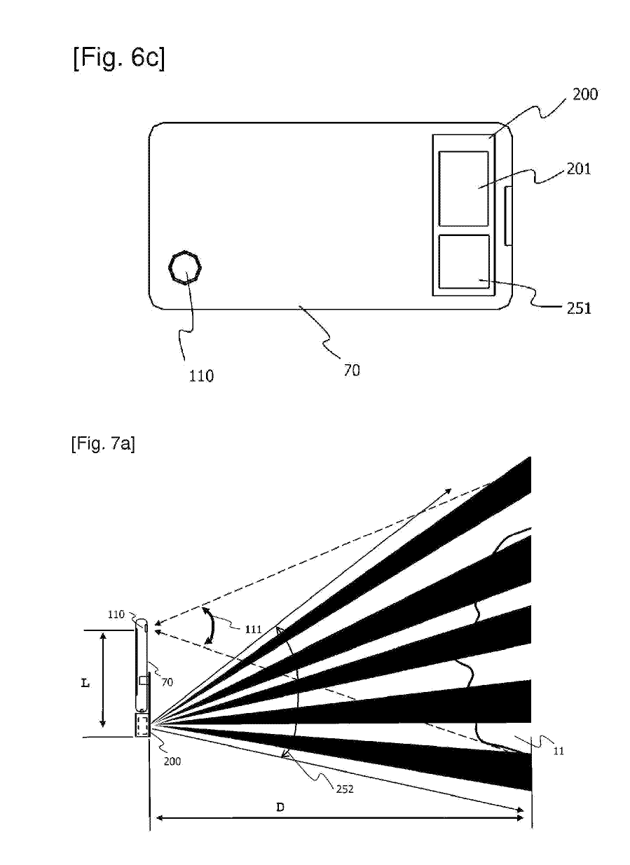

FIGS. 6a to 6c are views illustrating an example of an application method using the apparatus for projecting a grid pattern according to the present invention, respectively.

For example, the apparatus for projecting a grid pattern is an apparatus which may simply perform the three-dimensional measurement of the test object by sequentially projecting a plurality of grid patterns onto the test object at a predetermined position by coupling the grid pattern projecting means 200 with a PDA, a mobile phone, a digital camera, and the like, as mobile products provided with a camera and allowing the camera 110 to receive the projected grid patterns.

FIG. 6a is a plan view illustrating an example of the grid pattern projecting means 200 according to the embodiment of the present invention, in which the grid pattern projecting means 200 includes the grid pattern signal generation unit 201 and the grid pattern emitting unit 251, as well as a connector 521 for communicating the grid pattern information with external devices.

FIG. 6b is a plan view illustrating the grid pattern projecting means 200 according to the embodiment of the present invention which is coupled with the outside of the mobile device such as a smart phone 70 through the connector 521, in which the mobile device includes the camera 110 as the image input means, the information processing means 300 (not illustrated) built thereinto, and a monitor as an output means 400 mounted on the back surface thereof.

FIG. 6c is a plan view illustrating an example in which the grid pattern projecting means 200 according to the embodiment of the present invention is built into the mobile device such as the smart phone 70.

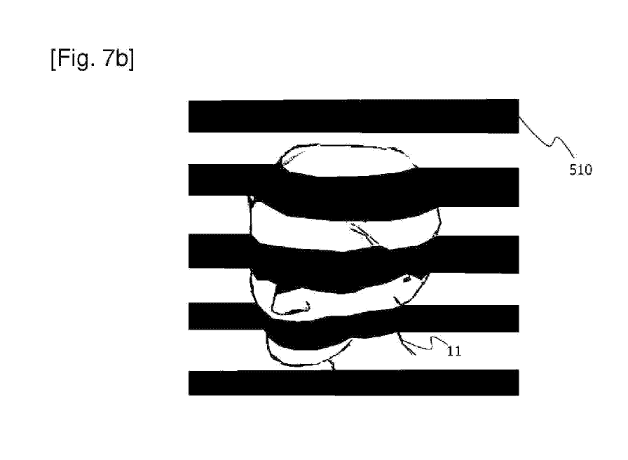

FIG. 7a is a side view illustrating an example in which the grid patterns are projected onto the test object by using the mobile products with the grid pattern projecting means 200 of FIG. 6b built thereinto, in which the test object 11 is spaced apart from the smart phone 70 by a predetermined distance D, the grid pattern projecting means 200 is mounted at a position spaced apart from the camera 110 by a predetermined distance L. Further, the grid pattern emitting unit of the grid pattern projecting means 200 projects the grid patterns onto the test object 11 at a predetermined projection angle 252 and then the projected grid pattern receives the image at a predetermined angle of view 111.

FIG. 7b is a perspective view illustrating an example of an image in which the projected grid pattern in FIG. 7a is projected onto the test object 11, in which the grid pattern image input the camera 110 is stored to perform a three-dimensional measurement operation by the information processing means 300, and displayed on the monitor by the output means 400.

### INDUSTRIAL APPLICABILITY

According to the present invention, the apparatus for projecting a grid pattern can be miniaturized by being internally or externally built into the mobile device and the three-dimensional device and can solve the problem of the focusing of the conventional apparatus for projecting a grid pattern and perform the three-dimensional measurement by projecting the grid pattern image onto the high-speed camera in real time.

Therefore, the present invention can use the three-dimensional image to the input apparatus by mounting the apparatus for projecting a grid pattern in the small electronic devices (for example, a smart phone, a smart pad) with the camera built thereinto and can be applied to a field of receiving the three-dimensional image in real time by coupling the camera with the apparatus for projecting a grid pattern according to the present invention, for example, the motion recognition field for three-dimensionally measuring the motion state of a user and the three-dimensional measurement and control field by being mounted in the smart TV.

1. An apparatus for projecting a grid pattern, comprising:
a grid pattern signal generating unit configured to generate a grid pattern signal by receiving grid pattern information so as to emit light to a test object and control the grid pattern signal;
a grid pattern projecting means which includes a grid pattern emitting unit configured to control a light source and a micro mirror for a laser scanner by using the grid pattern signal generated from the grid pattern signal generating unit to emit a grid pattern;
an image input means configured to allow a camera to receive a grid pattern image projected onto a surface of the test object;
an information processing means configured to provide a sequential projection timing of grid patterns and an input timing of the grid pattern image from the grid pattern signal generating means, receive and store the grid pattern image from the image input means, and form a three-dimensional image by extracting three-dimensional coordinates by using the received grid pattern image of the test object; and
an output means configured to display the three-dimensional image of the information processing means.

2. An apparatus for projecting a grid pattern, comprising:
a grid pattern signal generating unit configured to generate a grid pattern signal by receiving grid pattern information so as to emit light to a test object and control the grid pattern signal; and
a grid pattern projecting means which includes a grid pattern emitting unit configured to control a light source and a micro mirror for a laser scanner by using the grid pattern signal generated from the grid pattern signal generating unit to emit a grid pattern.

3. The apparatus of claim 1 or 2, wherein in the grid pattern projecting means, the grid pattern signal generating unit sequentially receives the grid pattern information and generates the grid pattern signal at the projection timing of the grid pattern using the received grid pattern information.

4. The apparatus of claim 1 or 2, wherein in the grid pattern emitting unit, the light source is configured of a line laser including a laser diode and at least one lens to irradiate light in a line pattern to a surface of the micro mirror for a laser scanner.

5. The apparatus of claim 4, wherein in the grid pattern emitting unit, the light of the line laser is collected in a line path in the line pattern by a cylinder lens and is irradiated to the surface of the micro mirror for a laser scanner.

6. The apparatus of claim 1 or 2, wherein in the grid pattern emitting unit, the micro mirror for a laser scanner includes a micro mirror for one-dimensional laser scanner which repeatedly rotates at a predetermined angle and period around one axis.

7. The apparatus of claim 1 or 2, wherein the grid pattern projecting means is internally or externally built in an apparatus in which the image input means, the information processing means, and the output means are mounted.

8. The apparatus of claim 1 or 2, wherein a pattern structure of the grid pattern image emitted from the grid pattern emitting unit is configured to have a grid pattern which is formed of at least one horizontal grid line image or at least one vertical grid line image.

9. The apparatus of claim 1, wherein the image input means receives the grid pattern image projected onto the test object at the projection timing of the grid pattern and transmits the received grid pattern image to the information processing means.

10. The apparatus of claim 1, wherein the information processing means is configured to control grid pattern signal information of the grid pattern signal generating unit and an image input timing of the image input means and extract three-dimensional coordinates by using the grid pattern image received by the image input means.
